(19) United States
(12) Patent Application Publication
(10) Pub. No.: US 2014/0047497 A1
(43) Pub. Date: Feb. 13, 2014

(54) METHOD AND SYSTEM FOR SYMBOL-RATE-INDEPENDENT ADAPTIVE EQUALIZER INITIALIZATION

(71) Applicant: Iberium Communications, Inc., San Francisco, CA (US)

(72) Inventors: Raul Alejandro Casas, Doylestown, PA (US); Stephen Leonard Biracree, Rochester, NY (US); Slobodan Simovich, San Francisco, CA (US); Thomas Joseph Endres, Seattle, WA (US)

(73) Assignee: Iberium Communications, Inc., San Francisco, CA (US)

(21) Appl. No.: 13/965,022

(22) Filed: Aug. 12, 2013

Related U.S. Application Data
(63) Continuation-in-part of application No. 12/381,375, filed on Mar. 10, 2009, now abandoned.
(60) Provisional application No. 61/069,211, filed on Mar. 12, 2008.

(51) Int. Cl. H04L 25/03; H04N 21/434

(52) U.S. Cl. CPC H04L 25/03878; H04N 21/434
USPC 725/151

(57) ABSTRACT

The current document is related to the equalization of digital communications signals, including GB 20600-2006 and ATSC digital television signals, and is directed to methods that initialize adaptive filters for processing payload data within equalizers. These methods may operate at a clock speed faster than the symbol transmission rate and are applicable to a multitude of digital communications standards and protocols. In certain implementations, the initialization method generates input records, from output of a pseudorandom number generator, and output records, from the output of a pseudorandom number generator and a channel estimate, that are decoupled from transmitted and received data and are used to adjust equalizer coefficients to an initialization setting suitable for processing payload data.

### CROSS-REFERENCE TO RELATED APPLICATION

This application is a continuation-in-part of Application No. 12/381,375, filed Mar. 10, 2009.

### TECHNICAL FIELD

The current document is related to the equalization of digital television signals, including GB 20600-2006 standard digital television signals in China and Advanced Television Systems Committee (“ATSC”) digital television signals in the USA.

### BACKGROUND

In digital television receivers, an equalization process is commonly employed in order to remove, from a received digital broadcast signal, multipath interference, noise, and additional types of interference that occur when original digital signals are broadcast. Removal of various types of interference represents an attempt to restore an original digital signal within a digital television receiver. Since the characteristics of the transmission channel are rarely known a priori to a digital television receiver, and since these characteristics change dynamically, equalizers that carry out the equalization process are often implemented using adaptive filters.

Most state-of-the-art digital receivers use some type of decision feedback equalizer (“DFE”), because decision feedback equalizers provide superior inter-symbol interference (“ISI”) cancellation with less noise gain than linear equalizers. A DFE acts to additively cancel ISI by subtracting filtered symbol estimates from the received waveform. In some cases, to reduce cost, a linear finite-impulse-response (“FIR”) equalizer is used rather than a DFE when adequate receiver performance is obtained using the linear FIR equalizer.

The GB 20600-2006 Chinese National Standard, published on Aug. 18, 2006, describes the physical layer characteristics of the digital television transmission adopted in China, which is already deployed in some regions. Approximately one third of the televisions sold in the world are sold in China.

### SUMMARY

The current document is related to the equalization of digital communications signals, including GB 20600-2006 and ATSC digital television signals, and is directed to methods that initialize adaptive filters for processing payload data within equalizers. These methods may operate at a clock speed faster than the symbol transmission rate and are applicable to a multitude of digital communications standards and protocols. In certain implementations, the initialization method generates input records, from output of a pseudorandom number generator, and output records, from the output of a pseudorandom number generator and a channel estimate, that are decoupled from transmitted and received data and are used to adjust equalizer coefficients to an initialization setting suitable for processing payload data.

### BRIEF DESCRIPTION OF THE DRAWINGS

FIG. 1 shows a digital television broadcast communication system.

FIG. 2 shows a digital receiver system.

FIG. 3 shows a decision feedback equalizer.

FIG. 4 shows a decision feedback equalizer that represents an implementation of the currently disclosed systems.

FIG. 5 shows channel emulation circuitry that represents an implementation of a component of the currently disclosed systems.

### DETAILED DESCRIPTION

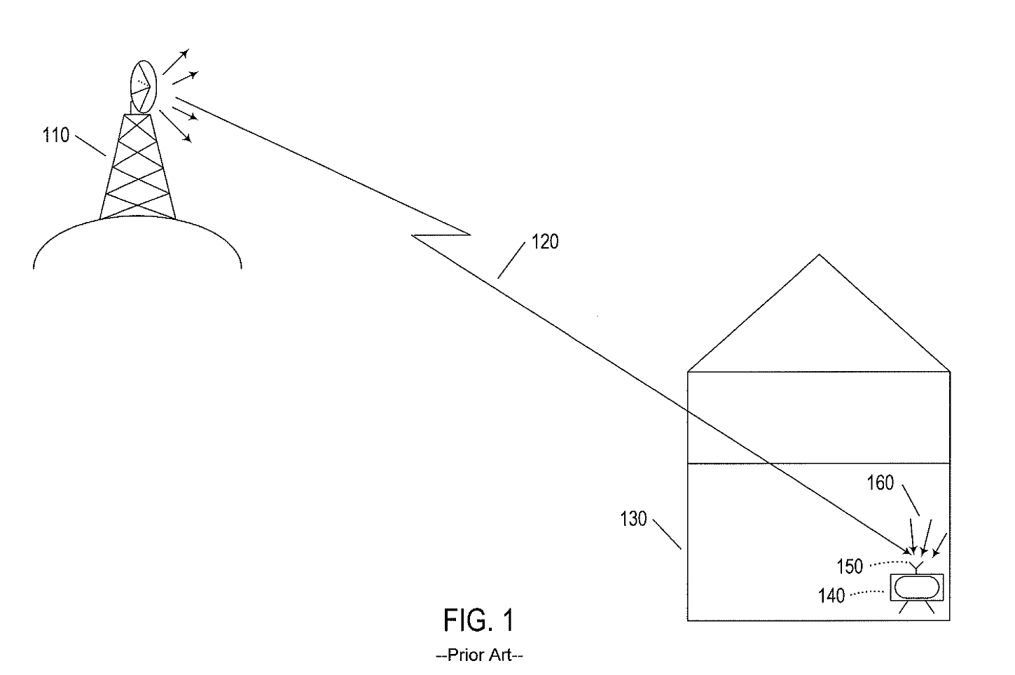

FIG. 1 depicts a digital television broadcast communication system. Transmitter station 110 broadcasts Digital Television (“DTV”) broadcast signal 120, which radiates through house 130 to television antenna 150. The induced penetration loss of the radio-frequency (“RF”) carrier's signal power through house 130 can be significant, often 20 dB or more. Television antenna 150 is usually either in close proximity to television 140 or is remotely connected to the television. The television antenna also receives multipath signals 160 that arise from reflection of the broadcast signal 120 and previously reflected signals by buildings and other reflective entities external to the house 130 as well as by items within the house 130, including walls, furniture, and people. Furthermore, in most viewing environments, the television 140 is located in a communal part of house 130, resulting in reflections from moving people that induce time-varying multipath signals. Reflections from moving cars and airplanes may cause additional time-varying multipath signals. Television 140 contains a receiver, connected or coupled to antenna 150, that is designed to extract the digital information encoded in the original broadcast signal transmitted by the transmitter station.

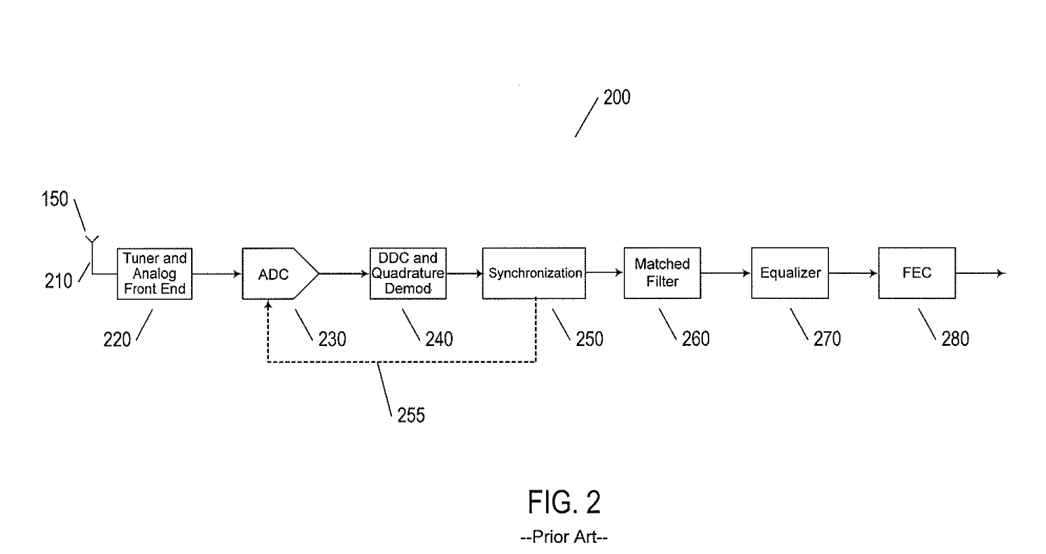

FIG. 2 shows a digital receiver system 200 which resides in television 140 of FIG. 1. In FIG. 2, the DTV broadcast signal 210 received by television antenna 150 is input to a tuner-and-analog-front-end module 220. The tuner-and-analog-front-end module 220 tunes to a particular broadcast channel, performs level setting, synchronization, frequency translation, filtering, and outputs, to analog-to-digital converter (“ADC”) 230, a processed signal centered at one of a standard intermediate frequency (“IF”), such as 44 MHz or 36 MHz depending on the country and location, a low IF frequency, or a zero IF frequency. ADC 230 digitizes the analog signal, typically 10-12 bits for DTV, and supplies a sample stream or streams to a direct digital down-converter (“DDC”) and quadrature-demodulation module 240. DDC and quadrature-demodulation module 240 performs direct digital down-conversion and an in-phase/quadrature-phase split into complex near-baseband, with the frequency translation depending on the IF frequency used. Additional filtering may be carried out. For example, rejection of adjacent broadcasts and other level-setting/gain adjustment may be carried out in the DDC and quadrature-demodulation module 240. The near-baseband signal from the DDC and quadrature-demodulation module 240 is output to a synchronization module 250. Synchronization module 250 aligns the sample rate and phase of the received samples to the transmitted data samples, typically either interpolating the data or adjusting the sample clock of ADC 230, shown in phantom 255. Carrier phase and frequency recovery may be carried out using pilot tone(s) that are embedded into the DTV data spectrum. Timed data from synchronization module 250 is supplied to matched filter 260, which typically performs square-root raised cosine filtering that is matched to the pulse shape filter applied at the transmitter 110. The output of matched filter 260 is baud-spaced, or a fraction of baud-spaced, and is supplied to Equalizer 270, which performs adaptive equalization to mitigate inter-symbol interference incurred in the broadcast channel. The term “baud,” equivalent in meaning to the phrase “symbol rate,” refers to the interval between adjacent symbols in the transmitted data sequence. Equalizer 270 may include a fine-carrier recovery loop, translating the data to a precise baseband. Equalizer 270 provides an equalized signal, with most ISI removed, to forward-error-correction (“FEC”) module 280, which performs forward error correction according to the channel coding methods applied to the data in the broadcast signal 120. FEC module 280 minimizes the received bit error rate and provides the recovered digital video signal, usually as MPEG packets, which can be decoded and viewed on a television. The currently disclosed methods and systems pertain to the equalizer 270 in digital receiver system 200.

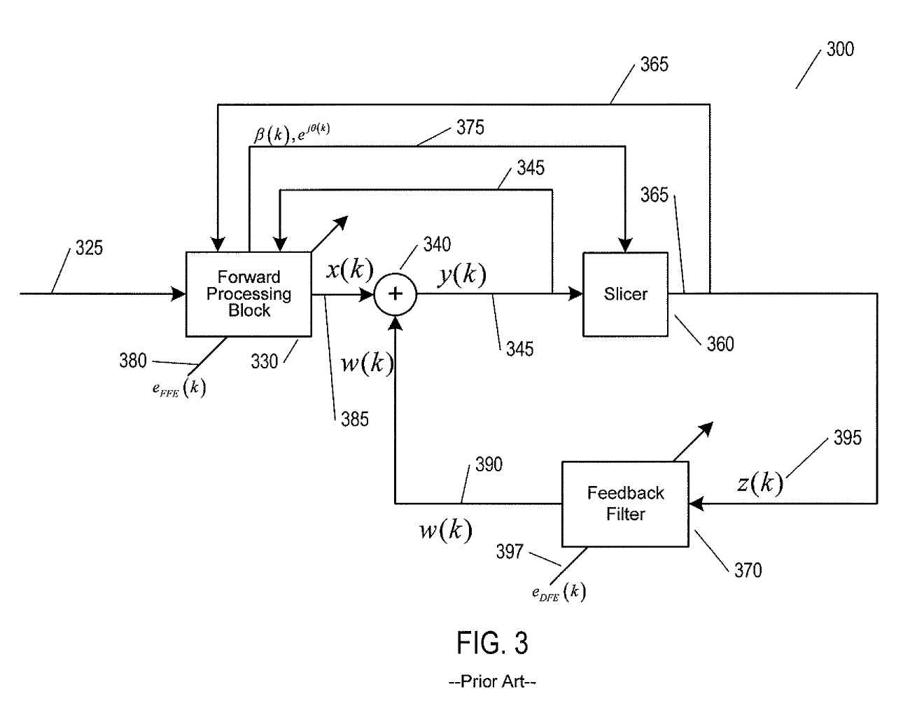

FIG. 3 shows a block diagram of a decision feedback equalizer. The equalizer 300 in FIG. 3 is suitable for Vestigial Sideband (“VSB”) signals, in accordance with the ATSC DTV broadcast standard, for quadrature-amplitude-modulation (“QAM”) signals, and for GB 20600-2006 signals. Decision feedback equalizer 300 is an example of equalizer 270 in FIG. 2. Decision feedback equalizer 300 in FIG. 3 encapsulates a linear FIR equalizer, which is realized by zeroing the coefficients and error terms used to adjust the coefficients in feedback filter 370.

Forward processing block 330 encompasses multiple signal processing functions and may include circuitry for adaptive forward filtering, carrier recovery, error term generation, and other functions.

Forward processing block 330 receives input samples 325 from front-end signal processing blocks of the digital receiver system 200. For example, the forward processing block, in certain digital receiver systems, receives input samples from matched filter 260, as shown in FIG. 2. Forward processing block 330 also receives an equalizer output sample y(k) 345, also referred to as a “soft decision sample,” which is also input to slicer 360, as well as output 365 of slicer 360, which is also input to feedback filter 370. Forward processing block 330 may provide output 375 to slicer 360. As one example, output 375 provides sine and cosine terms to slicer 360 when slicer 360 forms passband samples. Gain and phase-correction terms may also be supplied to slicer 360 from forward processing block 330. In FIG. 3, gain and phase-correction terms are represented by β(k) and θ(k), respectively, in β(k),e^{jθ(k)}. Forward processing block 330 also receives an error term e_{FFE}(k) 380, which can be used to adjust adaptive filter coefficients contained in forward processing block 330. Note that error term e_{FFE}(k) may be generated in forward processing block 330, in slicer 360, or elsewhere in the receiver. Forward processing block 330 contains a filter, usually adaptive, which filters input samples from front-end signal processing blocks of the digital receiver system 200 to produce output samples x(k) 385.

Adder 340 combines output samples x(k) 385 with feedback filter 370 output w(k) 390 to provide sample y(k) 345, referred to as an “equalizer output sample,” or as a “soft-decision sample,” to slicer 360. The combining can either be done with addition or subtraction, depending upon other polarity choices made in the design of the decision feedback equalizer.

Slicer 360 produces a symbol estimate, also referred to as a “hard decision sample.” Slicer 360 can be a nearest-element decision device, selecting the source symbol with minimum Euclidean distance to the soft decision sample, or can take advantage of the channel coding. For example, a partial trellis decoder is used as slicer 360 in certain decision feedback equalizers. Slicer 360 may also include a soft-symbol estimator, which processes a soft decision sample through a performance-enhancing non-linear function. Slicer 360 may also pass an equalizer output sample to the input of feedback filter 370, thus setting z(k)=y(k) so that the equalizer is configured in a linear IIR structure. Slicer 360 may also receive an input signal from forward processing block 330, for example, including sine and cosine terms which may be used for rotation and de-rotation.

The output from slicer 360 may be used as regressor sample z(k) 395 for feedback filter 370. Feedback filter 370 receives regressor samples z(k) 395 and produces output sample w(k) 390 to adder 340. Feedback filter 370 is usually implemented with adaptive coefficients, and is therefore provided error term e_{DFE}(k) 397, which may be generated in forward processing block 330, in slicer 360, or elsewhere in the receiver.

The adaptive filters contained in forward processing block 330 and feedback filter 370 may include real-valued or complex-valued coefficients, may process real-valued or complex-valued data, and may adjust coefficients or blocks of coefficients using real-valued or complex-valued error terms. The currently disclosed methods and systems initialize the coefficients in the adaptive filters contained in forward processing block 330 and feedback filter 370.

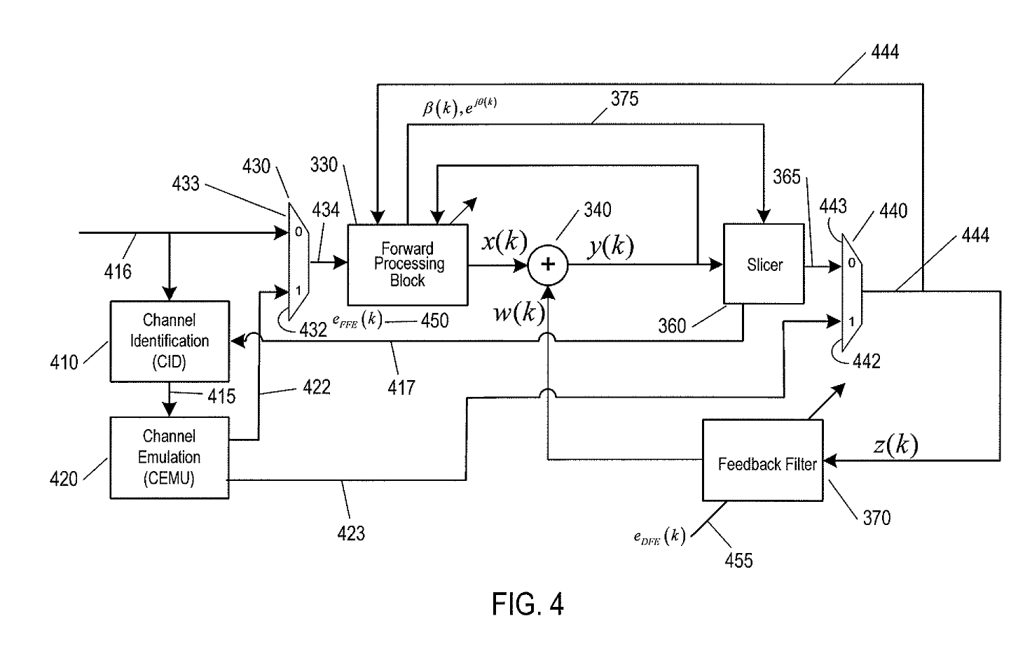

FIG. 4 shows a decision feedback equalizer that represents an implementation of the currently disclosed systems. Compared to the decision feedback equalizer 300 shown in FIG. 3, decision feedback equalizer 400 in FIG. 4 includes channel identification block 410, channel emulation block 420, and demultiplexers 430 and 440. Channel identification block 410 produces an estimate 415 of the channel impulse response, or channel estimate. Channel identification and estimation techniques are usually based on correlation methods. The channel estimate may be represented in the time domain or frequency domain, depending on the methods used in channel identification block 410, and may include estimates of inter-symbol interference, co-channel interference, additive noise processes, and other distortions with respect to the desired signal. Channel identification block 410 receives input samples 416 from front-end signal processing blocks of the digital receiver and also receives samples 417 from slicer 360. Samples 417 provided from slicer 360 to channel identification block 410 can be hard decision samples z(k) or can be generated differently from hard decision samples z(k). For example, the samples 417 can correspond to pilot or training data embedded in the broadcast signal 120 and therefore generated or stored locally in slicer 360, or elsewhere in receiver system 200, to be used in estimation processes. Channel identification block 410 provides a channel estimate 415 to channel emulation block 420.

Channel emulation block 420 receives a channel estimate 415 from channel identification block 410. This channel estimate is used, in channel emulation block 420, to create an input record and output record which can be independent of the transmitted data and used in decision feedback equalizer 400 to adjust adaptive filter coefficients in forward processing block 330 and feedback filter 370. The rate of adjustment of adaptive filter coefficients in forward processing block 330 and feedback filter 370 may be done at the symbol rate, faster than the symbol rate, or slower than the symbol rate. The output record 422 from channel emulation block 420 is output to the “1” input port 432 of demultiplexer 430. The “0” port 433 of demultiplexor 430 receives the output 416 of a matched filter (260 in FIG. 2), which is the input to decision feedback equalizer 400. The output 434 of demultiplexor 430 is coupled to forward processing block 330, and may serve as the input to the adaptive filter in forward processing block 330.

The input record 423 from channel emulation block 420 is coupled to the “1” input port 442 of demultiplexor 440. The “0” port 443 of demultiplexor 440 is connected to the output 365 of slicer 360. The output 444 of demultiplexor 440 is coupled to feedback filter 370, and can serve as the input (or regressor) data z(k) for adaptive feedback filter 370. Output 444 of demultiplexor 440 is also coupled to forward processing block 330.

When input port “0” is selected in demultiplexers 430 and 440, decision feedback equalizer 400 operates analogously to prior art decision feedback equalizer 300 illustrated in FIG. 3. Selection of input port “0” in decision feedback equalizer 400 is used to process payload data embedded in a broadcast signal. Without properly initializing the coefficients of the adaptive filters in forward processing block 330 and feedback filter 370, adaptation of these coefficients using the payload data supplied by selecting port “0” in demultiplexers 430 and 440 results in divergence of these coefficients from a setting that provides a suitable error rate. In short, the equalizer crashes catastrophically, relying on slow control processes to detect the failure and restart the adaptation process, causing, at best, delay and, at worst, unrecoverable data loss. It is therefore highly desirable to initialize the coefficients of the adaptive filters in forward processing block 330 and feedback filter 370 to a setting that facilitates the adaptation to payload data when switched to port “0” in demultiplexers 430 and 440, to prevent coefficient divergence and equalizer crashes.

According to the currently disclosed methods and systems, when a valid channel estimate is found and provided to channel emulation block 420 from channel identification 410, selecting port “1” in demultiplexers 430 and 440 facilitates running the circuitry in decision feedback equalizer 400 to establish a setting of coefficients in forward processing block 330 and feedback filter 370 that provides an initialization setting suitable for operation on payload data when port “1” is changed to port “0”. Both the input and output data records 422-423 are supplied from the channel emulation block 420 to forward processing block 330 through demultiplexers 430 and 440 to form regressor data for the adaptive filter, error terms e_{FFE}(k) 450 and e_{DFE}(k) 455, and gain and phase correction terms β(k), e^{jθ(k)} 375. The output data record 422 from the channel emulation block 420 is also used to form a feedback sample z(k) 444, input to the feedback filter 370, through demultiplexor 440. When port “1” is selected, the connection to matched filter 260, and therefore also the front end blocks of the receiver 200, are disconnected from decision feedback equalizer 400. Because of this disconnection, when port ‘1” is selected, the circuitry in decision feedback equalizer 400 is off-line with respect to the front end blocks of receiver system 200 and can be run at a rate independent of the symbol rate, the rate at which the circuitry would normally be running when port “0” is selected. Therefore when port “1” is selected, the circuitry can be run at an accelerated rate compared to the symbol rate. In fact, it can run as quickly as input and output records can be generated and processed, limited by the hardware/software architecture choices, not the symbol rate. Therefore the initialization setting of the coefficients of the adaptive filters in forward processing block 330 and feedback filter 370 is generated off-line, without using a data stream from matched filter 260, and achieves initialization very quickly compared to other methods which are constrained to processes limited by the symbol rate. For example, in many currently available receivers, correlation of the received data is performed against stored pilot symbols. Because the correlation depends on the received data stream as an input to the correlation process, the rate at which the correlation circuitry can be run is limited by the symbol rate. The currently disclosed methods and systems provide superior convergence to an equalizer initialization setting compared to commonly available methods which limit the rate of adaptation by the symbol rate. In addition, currently available methods assume that the received data stream is connected to the correlation circuitry and cannot be decoupled from the correlation circuitry during operation, because the channel information is carried in the received data stream. In contrast, in the currently disclosed methods and systems, channel information is contained in a channel estimate, and the received data is disconnected during operation.

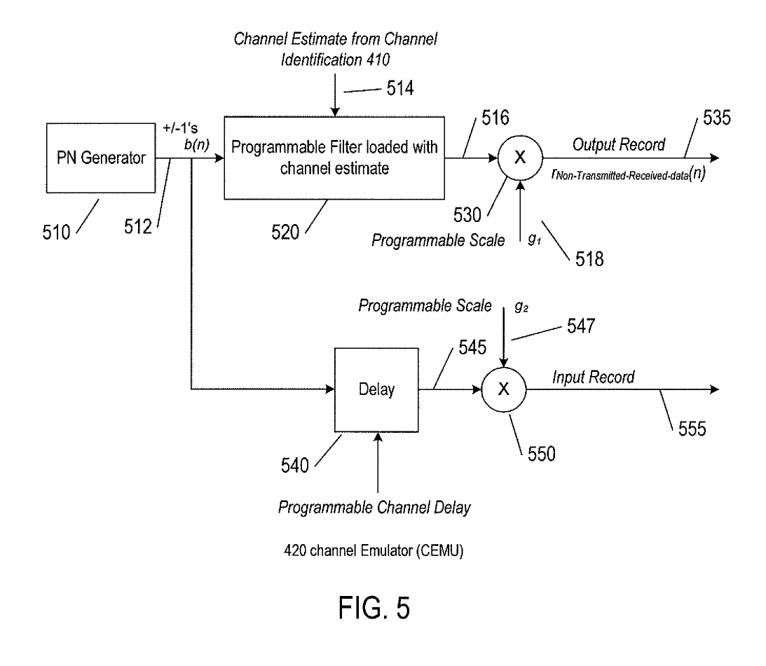

FIG. 5 shows channel emulation circuitry that represents an implementation of a component of the currently disclosed systems. Channel emulation block (420 in FIG. 4) creates a non-transmitted mock-data sequence b(n) 512, in certain implementations using a pseudo-random-number generator, and filters the non-transmitted mock-data sequence through the channel estimate provided by channel identification block 420, thus creating an input/output data record that can be used to train the adaptive filters in forward processing block (330 in FIG. 4) and feedback filter (370 in FIG. 4). The non-transmitted mock-data sequence is so named because it need not be correlated with any portion of the transmitted data and need not correspond to any pilot, training, or reference data.

Pseudo random-number generator 510 creates a real-valued or complex-valued sequence of random +1/−1's, in one implementation based on a common test signal referred to as the PN23 sequence (pseudo noise of 2²³−1 random bits) that is implemented with a linear feedback shift register. This sequence is referred to as “non-transmitted mock data” and is denoted by b(n) in FIG. 5.

Note that, because the non-transmitted mock data is composed of +1/−1's, it is not a legal alphabet member in the transmitted sequence for almost all real world standards and protocols. The non-transmitted mock data is not used in currently available methods, in which the training data is constrained to be equal to, or correlated with, data in the transmitted data sequence. Furthermore, because the sequence of +1/−1's is selected independently of the standard or protocol used, the currently disclosed methods are generic, and can be applied with little or no change to a variety of real word standards and protocols supporting a variety of bandwidths, modulation schemes, and data rates. The currently disclosed methods and systems are therefore far more flexible than currently available methods.

Non-transmitted mock data 512 from pseudo random-number generator 510 is supplied as input to programmable filter 520. Programmable filter 520 is loaded with filter coefficients 514 from a channel estimate provided by channel identification block 410. The regressor data, comprising a sequence of +1/−1's, provides for efficient filtering. The filtered data 516 output from programmable filter 520 is scaled in multiplier 530 by a programmable scale, g₁, 518. The scale g₁ is selected according to the modulation and other specifics about the standard or protocol of the broadcast signal. The output 535 of multiplier 530 is the output record of channel emulator 420, and is denoted by “r_{Non-Transmitted-Received-Data}(n)” to emphasize that the output record is used as received data in equalizer 400, but is not generated from, and does not correspond to, training, reference, or pilot data in the broadcast signal.

The output record of channel emulator 420 is therefore calculated according to:

$${r}_{Non \text{-} Transmitted \text{-} Received \text{-} Data} ( n ) = {g}_{1} ( \begin{matrix}{\sum }_{k = 0}^{N {-}^{′}} {c}_{I} ( k ) \cdot b ( n - k ) + \\ j \cdot {\sum }_{k = 0}^{N - 1} {c}_{Q} ( k ) \cdot b ( n - k )\end{matrix} ) ,$$

where g₁ is the programmable scale used in multiplier 530; c₁(n)+j·c_{Q}(n) are the channel estimate impulse response coefficients; and b(n) is the non-transmitted mock data, or random sequence of +1/−1's from pseudo random-number generator 510.

The random output 512 of pseudo random-number generator 510, or non-transmitted mock data denoted by b(n), is also provided to delay element 540, which delays the non-transmitted mock data by a value determined from a programmable channel delay. This programmable channel delay determines the position of the main equalizer coefficient, or “cursor.” The output 545 of delay element 540 is scaled by a second programmable scale 547, denoted by “g₂,” in multiplier 550, and the result 555 is the input record produced by channel emulator 420. The scale g₂ is selected according to the modulation and other specifics about the standard or protocol of the broadcast signal. The input record and output record can be used to generate equalizer errors e_{FFE}(k) and e_{DFE}(k), gain and phase correction terms β(k),e^{jθ(k)}, and regressor data for adaptive filters in forward processing block 330 and feedback filter 370, in place of actual transmitted and received data.

During an initialization mode, when port “1” is selected in demultiplexers 430 and 440 in FIG. 4, prior to processing payload data in the equalizer when the port is switched to port “0” in demultiplexers 430 and 440, the output record, or non-transmitted-received-data, is generated by filtering non-transmitted mock data through a channel estimate and, together with the input record, forms sufficient data to operate the circuitry in decision feedback equalizer 400 with no data from the front-end processing blocks in receiver 200 The decision feedback equalizer 400 can be therefore trained indirectly from the channel estimate, without ever performing a costly matrix inverse, to a setting suitable for adaptation to payload data, using channel emulation block 420.

Although the present invention has been described in terms of particular embodiments, it is not intended that the invention be limited to these embodiments. Modifications within the spirit of the invention will be apparent to those skilled in the art. For example, the above-provided equations may include scaling, change of sign, or similar constant modifications that are not shown for simplicity. Such modifications can be readily determined or derived for a particular implementation. Thus, the described equations may be subject to such modifications and are not limited to the exact forms provided above. The various functions of equalization, signal combining, error correction, and carrier recovery may be implemented with circuit elements or may also be implemented in the digital domain as processing steps in a control program. A control program, implemented as a sequence of computer instructions stored in an instruction-storage device, may be employed in, for example, a digital signal processor, micro-controller, or general-purpose computer. The currently disclosed methods and systems can be embodied in the form of programs, comprising sequences of processor instructions, encoded in tangible media, such as floppy diskettes, CD-ROMs, hard drives, and other machine-readable storage medium, wherein, when the program is loaded into, and executed by, a machine, such as a computer, the machine becomes an apparatus for practicing the invention. When implemented on a general-purpose processor, the program combines with the processor to provide a unique device that operates analogously to specific logic circuits. While the currently disclosed methods and systems are described, above, in the context of DTV receivers, the methods and systems can be applied to equalizer initialization within additional types of communications receivers.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An equalizer within a communications receiver, the equalizer comprising:
a payload-processing module that reduces intersymbol interference within samples received from front-end signal processing blocks of the communications receiver; and
an initializer module that generates non-transmitted mock data used to initialize adaptive filters within the payload-processing module.

2. The equalizer of claim 1 wherein the payload-processing module receives inputs from one of two sources through a switch that is controlled to select input from one of the two sources.

3. The equalizer of claim 1 further comprising:
a first demultiplexer that receives input samples from front-end signal processing blocks of the communications receiver, through a first port, and that receives non-transmitted-mock-data input data, through a second port, and that is controlled to output either the input samples from front-end signal processing blocks of the communications receiver or the non-transmitted-mock-data input data; and
a second demultiplexer that receives processed input samples, through a first port, and that receives non-transmitted-mock-data output data, through a second port, and that is controlled to output either the processed input samples or the non-transmitted-mock-data output data.

4. The equalizer of claim 3 wherein the payload-processing module comprises
a forward processing block that receives output from the first demultiplexer, that includes an adaptive filter, and that generates first output samples that are processed to generate processed input samples; and
a feedback filter that includes an adaptive filter, that receives output from the second demultiplexer, and that produces second output samples.

5. The equalizer of claim 4 wherein the payload-processing module further comprises:
a combiner that combines the first output samples with the second output samples to produce an equalizer output sample; and
a slicer that receives the equalizer output sample and that produces a symbol estimate that is output to a first port of the second demultiplexer.

6. The equalizer of claim 4 wherein the initializer module comprises:
the first and second demultiplexers;
a channel identifier that receives input samples from front-end signal processing blocks of the communications receiver and that produces a channel estimate; and
a channel emulator that receives the channel estimate from the channel identification block and that generates non-transmitted-mock-data input data that is transferred to the forward processing block through the second port of the first demultiplexer and that generates non-transmitted-mock-data output data that is transferred through the second port of the second demultiplexer to the feedback filter, the non-transmitted-mock-data input data and non-transmitted-mock-data output data used to adjust adaptive filter coefficients in the forward processing block and the feedback filter.

7. The equalizer of claim 4 wherein, when input to the first port of the first demultiplexer is output to the forward processing block and input to the first port of the second demultiplexer is output to the feedback filter, the equalizer processes data received from remote source.

8. The equalizer of claim 4 wherein, when input to the second port of the first demultiplexer is output to the forward processing block and input to the second port of the second demultiplexer is output to the feedback filter, the equalizer processes non-transmitted mock data generated by the initializer module as training data in order to adjust internal parameters of the payload-processing module, including coefficients used by the adaptive filer of the forward processing block.

9. The equalizer of claim 4 wherein the input samples from front-end signal processing blocks of the communications receiver are received from a matched filter and wherein the equalizer outputs processed equalized output signals to a forward error-correction module.

10. A method for training an equalizer within a communications receiver that includes a payload-processing module that reduces intersymbol interference within samples received from front-end signal processing blocks of the communications receiver, the method comprising:
including an initializer module that generates non-transmitted mock data within the equalizer; and
selectably routing non-transmitted mock data to the payload-processing module to train the equalizer.

11. The equalizer of claim 10 wherein the payload-processing module receives inputs from one of two sources through a switch that is controlled to selectably route non-transmitted mock data to the payload-processing module to train the equalizer.

12. The method 10 wherein the equalizer further comprises:
a first demultiplexer that receives input samples from front-end signal processing blocks of the communications receiver, through a first port, and that receives non-transmitted-mock-data input data, through a second port, and that is controlled to output either the input samples from front-end signal processing blocks of the communications receiver or the non-transmitted-mock-data input data; and
a second demultiplexer that receives processed input samples, through a first port, and that receives non-transmitted-mock-data output data, through a second port, and that is controlled to output either the processed input samples or the non-transmitted-mock-data output data.

13. The method of claim 12 wherein the payload-processing module comprises
a forward processing block that receives output from the first demultiplexer, that includes an adaptive filter, and that generates first output samples that are processed to generate processed input samples; and
a feedback filter that includes an adaptive filter, that receives output from the second demultiplexer, and that produces second output samples.

14. The method of claim 13 wherein the payload-processing module further comprises:
a combiner that combines the first output samples with the second output samples to produce an equalizer output sample; and
a slicer that receives the equalizer output sample and that produces a symbol estimate that is output to a first port of the second demultiplexer.

14. The method of claim 13 wherein the initializer module comprises:
the first and second demultiplexers;
a channel identifier that receives input samples from front-end signal processing blocks of the communications receiver and that produces a channel estimate; and
a channel emulator that receives the channel estimate from the channel identification block and that generates non-transmitted-mock-data input data that is transferred to the forward processing block through the second port of the first demultiplexer and that generates non-transmitted-mock-data output data that is transferred through the second port of the second demultiplexer to the feedback filter, the non-transmitted-mock-data input data and non-transmitted-mock-data output data used to adjust adaptive filter coefficients in the forward processing block and the feedback filter.

15. The method of claim 13 wherein, when input to the first port of the first demultiplexer is output to the forward processing block and input to the first port of the second demultiplexer is output to the feedback filter, the equalizer processes data received from remote source.

16. The method of claim 13 wherein, when input to the second port of the first demultiplexer is output to the forward processing block and input to the second port of the second demultiplexer is output to the feedback filter, the equalizer processes non-transmitted mock data generated by the initializer module as training data in order to adjust internal parameters of the payload-processing module, including coefficients used by the adaptive filer of the forward processing block.

17. The method of claim 13 wherein the input samples from front-end signal processing blocks of the communications receiver are received from a matched filter and wherein the equalizer outputs processed equalized output signals to a forward error-correction module.
